(19) United States
(12) Patent Application Publication
(10) Pub. No.: US 2006/0105723 A1
(43) Pub. Date: May 18, 2006

(54) Simple crest factor reduction technique for non-constant envelope signals

(76) Inventor: Kiomars Anvari, Alamo, CA (US)

Correspondence Address: KIOMARS ANVARI, 1567 SERAFIX RD, ALAMO, CA, 94507, US

(21) Appl. No.: 10/989,801

(22) Filed: Nov. 17, 2004

(51) Int. Cl. H04B 1/04

(52) U.S. Cl. 455/114.2

(57) ABSTRACT

A technique for Crest Factor reduction of non-constant envelope signals is described. The input to any nonlinear circuit is modified by a Crest Factor reduction circuit, prior to being applied to the nonlinear circuit. The Crest Factor reduction circuit can either be performed at baseband or RF/IF frequencies. When performed at baseband the real and imaginary components of the baseband signal individually are applied to the Crest Factor reduction circuit. When performed at RF/IF the real signal is directly applied to the Crest Factor reduction circuit. The Crest Factor reduction divides the signal in two equal components one in-phase and one quadrature phase. Each component is then individually clipped based on magnitude of the real or complex signal and then filtered before being combined again by a combiner that 90 degree phase shifts the in-phase component before combining . In the case of RF/IF the clipped signal is bandpass filtered. The Crest Factor reduction could be performed in digital or analog domain.

### BACKGROUND OF INVENTION

The present invention relates to a Crest Factor reduction circuit to boost the out put power of a wireless RF amplifier. The Crest Factor reduction circuit input could be baseband, intermediate frequency (IF), or RF signal. and its output is the Crest Factor reduced baseband or IF/RF signal as a new input to the amplifier. In any wireless communication system one of the critical components is the power amplifier. This component has a major contribution in cost, power consumption, and size of the system. The main reason is the requirement of wireless radio communication system for linear amplifiers. The higher the linearity, the higher the power consumption, cost and size. In order to minimize the cost, size and power consumption there is a need for techniques that overcome this problem. This invention conquers these challenges by using a simple and accurate Crest Factor reduction module used at the input to the amplifier.

### SUMMARY OF INVENTION

According to the invention, a low-cost Crest Factor reduction circuit, for use with RF amplifier, uses a plurality of simple and accurate circuits in conjunction with intelligent signal processing to improve power handling of the RF amplifier. By intelligent, it is meant that the Crest Factor reduction module has features of removing the unwanted signals after applying the crest factor reduction function. The Crest Factor reduction module uses the amplifier input which could be a baseband, an IF or RF signal as its input and conditions the input before applying to the amplifier. The conditioning or Crest Factor reduction helps to boost the power handling of the amplifier or acts more linearly. The inputs to the Crest Factor reduction should be within a limit that can be handled by the Crest Factor reduction module.

In a particular embodiment, the Crest Factor reduction unit comprises a quadrature divider, clipping circuits, filter and a quadrature combiner. Depending on the nature of the baseband signal the implementation of the components of Crest Factor reduction will be different. In the case of IF/RF signal the Crest Factor reduction has bandpass properties and when the signal is complex baseband the Crest Factor reduction circuit has baseband properties. In both cases the Crest Factor reduction circuit can be either implemented in digital or analog domain.

The invention will be better understood by reference to the following detailed description in conjunction with the accompanying drawings.

### BRIEF DESCRIPTION OF THE DRAWINGS

FIG. 1 is an overall block diagram of the an amplifier with a booster using Crest Factor reduction

FIG. 2 is the block diagram of the RF/IF Crest Factor reduction circuit

FIG. 3 is the detail block diagram of the RF/IF Crest Factor reduction circuit

FIG. 4 is the block diagram of the baseband Crest Factor reduction with RF/IF input and output signals

FIG. 5 is the block diagram of the baseband Crest Factor reduction circuit with baseband input and RF/IF output signal

FIG. 6 is the block diagram of the digital signal processing block performing the Crest Factor reduction

FIG. 7 is the block diagram of the Crest Factor algorithm

FIG. 8 is the block diagram of Crest Factor reduction algorithm using baseband real signal

FIG. 9 is the detail block diagram of Crest Factor reduction algorithm using baseband complex signal

FIG. 10 is the block diagram of the clipping circuit

### DESCRIPTION OF THE SPECIFIC EMBODIMENTS

In a first preferred embodiment the Crest Factor reduction circuit monitors the signal strength of the input signal channels using the input receiver and finds the frequency and channel number of the input signals. In a second preferred embodiment of the invention, the Crest Factor reduction circuit is implemented at RF/IF frequency. In a third preferred embodiment of the invention, the Crest Factor reduction circuit uses sub-harmonic sampling to convert RF or IF signals to digital baseband signal. In a fifth preferred embodiment the input signal is conditioned or Crest Factor reduced using the baseband signal. In a sixth embodiment the Crest Factor reduction is applied on baseband real signal. In a seventh embodiment the Crest Factor reduction is applied on both real and imaginary components of the baseband signal. In an eighth embodiment the signal is amplitude clipped or limited either in analog or digital domain. In a ninth embodiment the baseband clipping circuit uses the magnitude of the complex baseband signal to determine the multiplication factor used for the I or Q signal that performs the clipping. In a tenth embodiment each clipped signal is individually filtered to reject the unwanted signals produced due to clipping and maintaining the final modulation accuracy of the baseband signal.

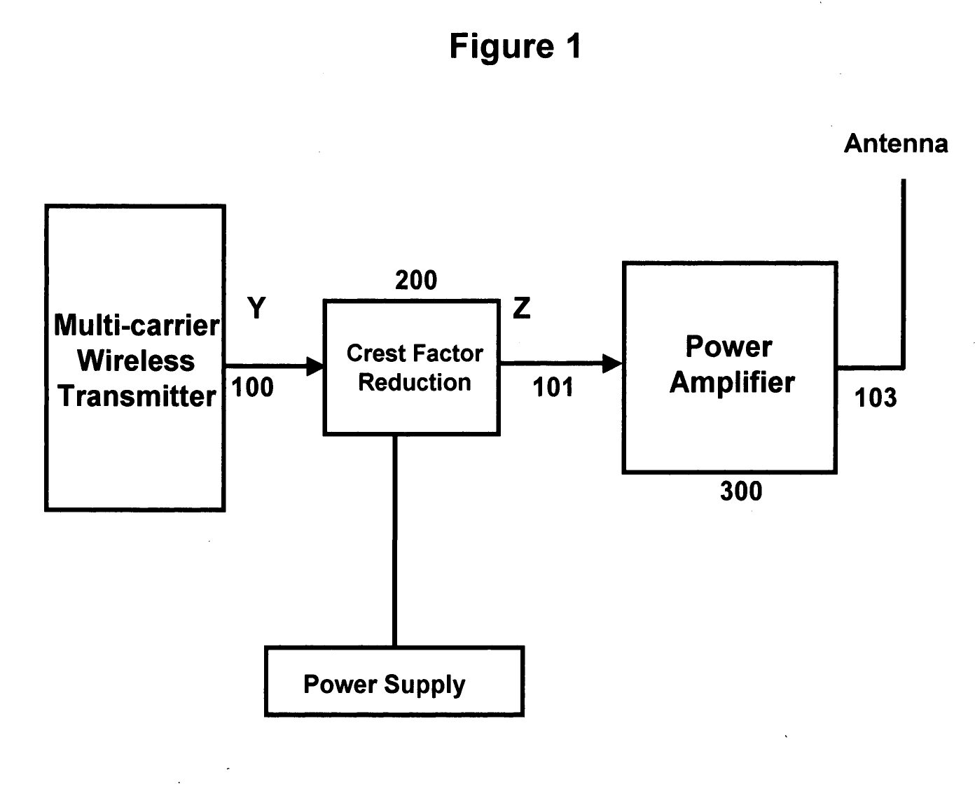

Referring to FIG. 1, a Crest Factor reduction circuit diagram is illustrated. The systems receive its inputs from wireless transmitter 100. The output of the Crest Factor reduction circuit 200 is applied to the input of the amplifier. The Crest Factor reduction circuit performs the following functions:
1. Finds the frequencies and channel numbers of the wireless transmitter output 100.
2. Reduce the Crest Factor of the input signal 100 before applying to amplifier.
3. Adaptively adjust the gain in the signal paths to keep the total gain from input to output of the Crest Factor reduction one.

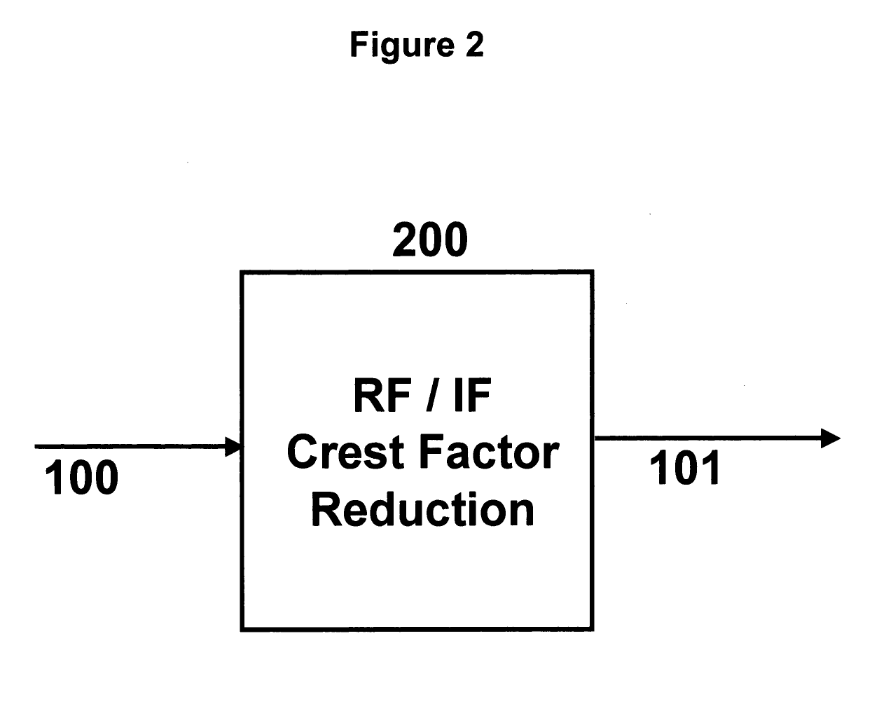

FIG. 2 illustrates the detail block diagram of the RF/IF Crest Factor reduction circuit. The received signal from wireless transmitter 100 is applied to Crest Factor reduction circuit 200 to produce the Crest Factor reduced signal 101. The Crest Factor is performed in analog domain at RF or IF frequencies.

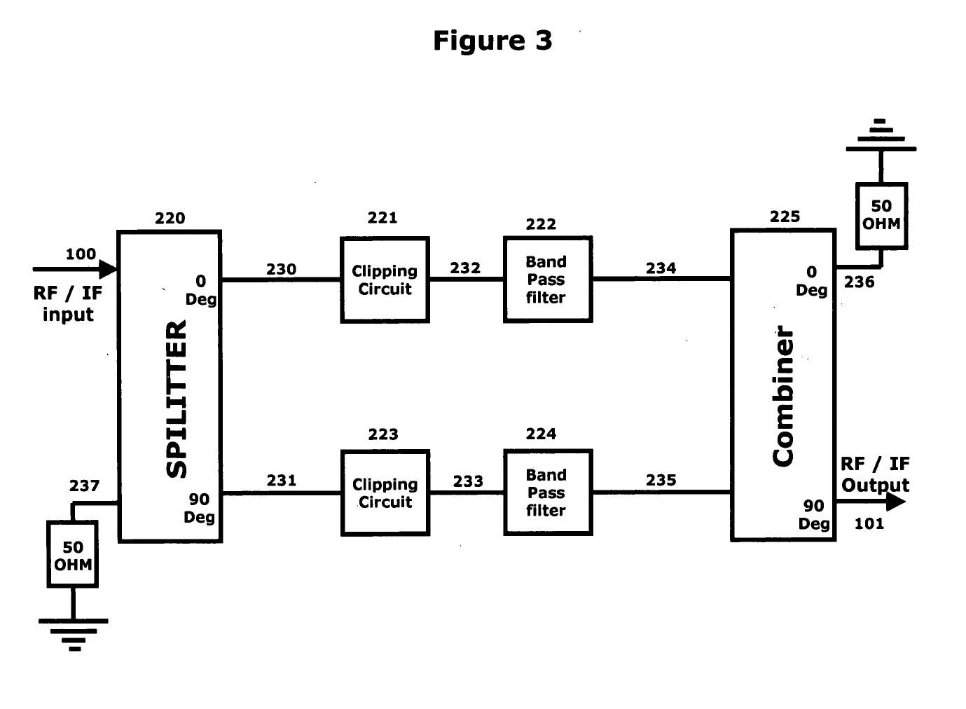

FIG. 3 shows the detail of the RF/IF Crest Factor reduction circuit. The RF/IF signal 100 is applied to a quadrature hybrid splitter 220 to produced in phase and quadrature signals 230, and 231. The in phase and quadrature signals 230 and 231 are applied to clipping circuits 221 and 223 to produce the clipped signals 232 and 233. The clipped signals 232 and 233 are then bandpass filtered by bandpass filters 222 and 224 to produce filtered signals 234 and 235. The amplitude clipped and band pass filtered signals 234 and 235 are combined by the hybrid quadrature combiner 225 to produce the Crest Factor reduced signal 101.

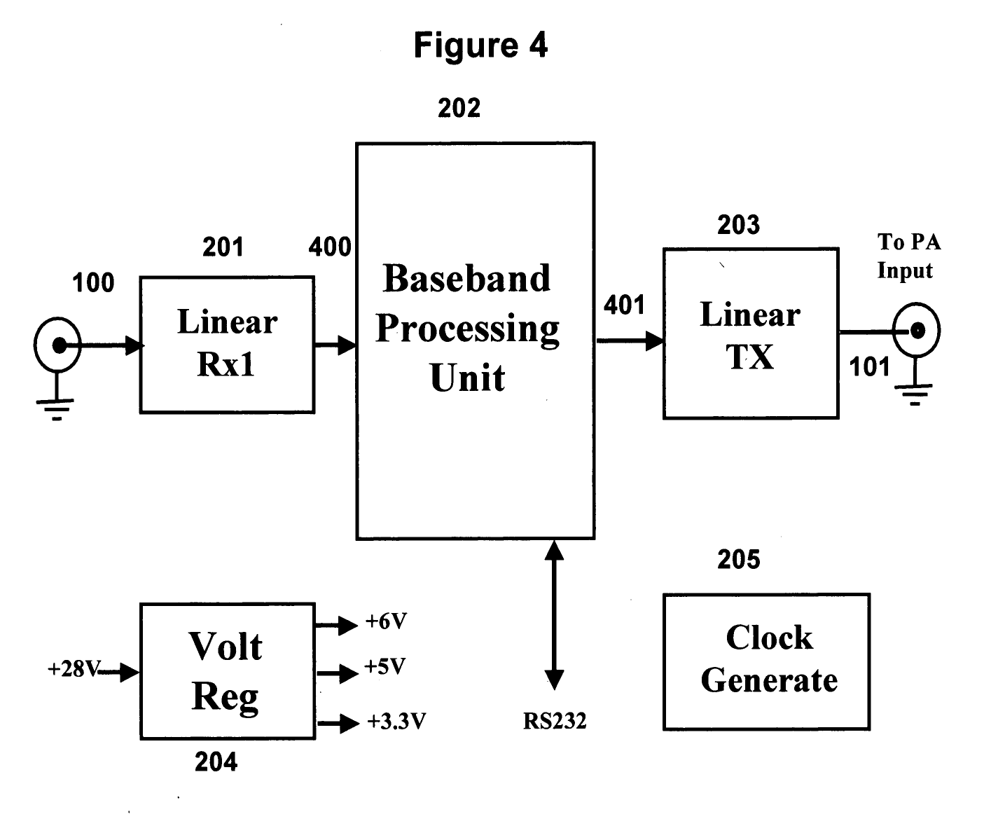

FIG. 4 illustrates the detail block diagram of the baseband Crest Factor reduction circuit unit. The received signal from wireless transmitter 100 is applied to receiver 201 to produce signal 400. The output of the receiver 201 is applied to signal processing block 202 for digital signal processing which is Crest Factor reduction and filtering of baseband signal. The output of signal processing block 202 the Crest Factor reduced signal 401 is applied to transmitter 203 to create the input signal 101 for the amplifier. Clock generator 205 produces all the clocks necessary for the Crest Factor reduction circuit and the power supply block 204 produce all the voltages necessary for the Crest Factor reduction circuit.

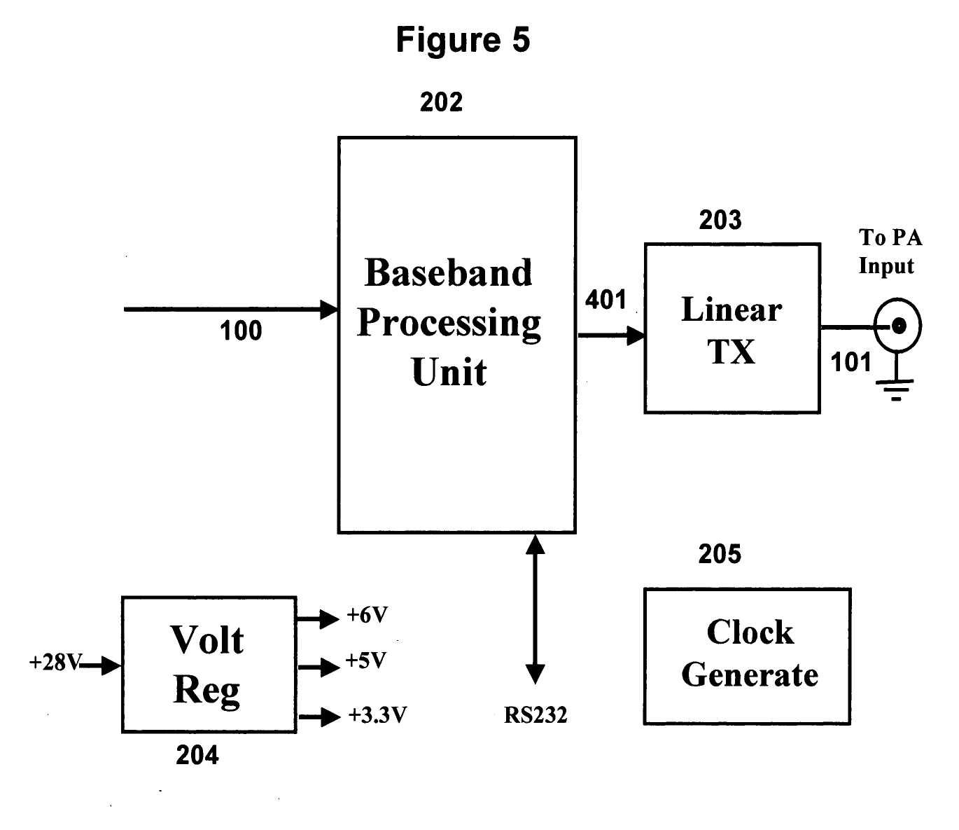

FIG. 5 illustrates the detail block diagram of the baseband Crest Factor reduction circuit when the output of wireless transmitter is a baseband signal. The received signal from wireless transmitter 100 is applied to signal processing block 202 for digital signal processing which is Crest Factor reduction and filtering of baseband signal. The output of signal processing block 202 the Crest Factor reduced signal 401 is applied to transmitter 203 to create the input signal 101 for the amplifier. Clock generator 205 produces all the clocks necessary for the Crest Factor reduction circuit and the power supply block 204 produce all the voltages necessary for the Crest Factor reduction circuit.

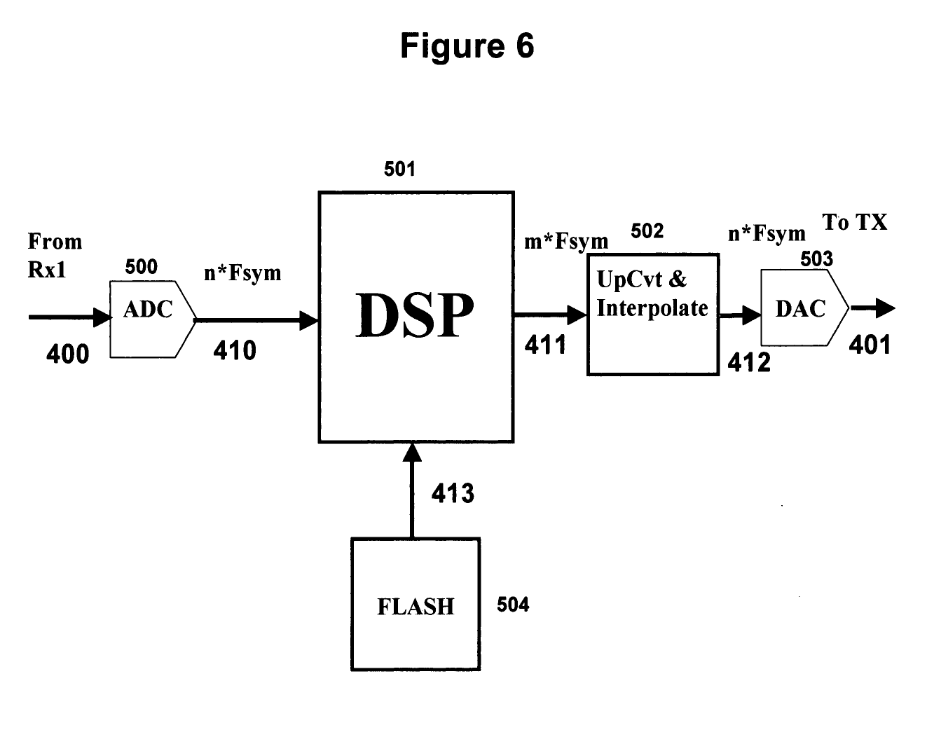

FIG. 6 shows the detail block diagram of the Crest Factor reduction signal processing block 202. The receiver block 201 output 400 is applied to analog to digital converter (in case the signal is RF, IF, or baseband) block 500 to produce the digital signal 410. If the signal is RF or IF the analog to digital conversion is based on sub-harmonic sampling. The output of the analog to digital converter 500 is applied to the DSP block 501 for down conversion and decimation to produce “m” sample per symbol. In case the signal is a baseband the signal may need to be interpolated or decimated to produce the right number of samples per symbol. If the signal is baseband but in bit format the up conversion function of 501 is used. The signal is converted to symbol domain with desired samples per symbol. The DSP block 501 also performs the Crest Factor reduction and produces signal 411. The Crest Factor reduced signal 411 is applied to up converter and interpolator 503 to produce the up converted and interpolated signal 412. Signal 412 is applied to digital to analog converter 503 to produce the analog signal 401 for the transmitter block 203.

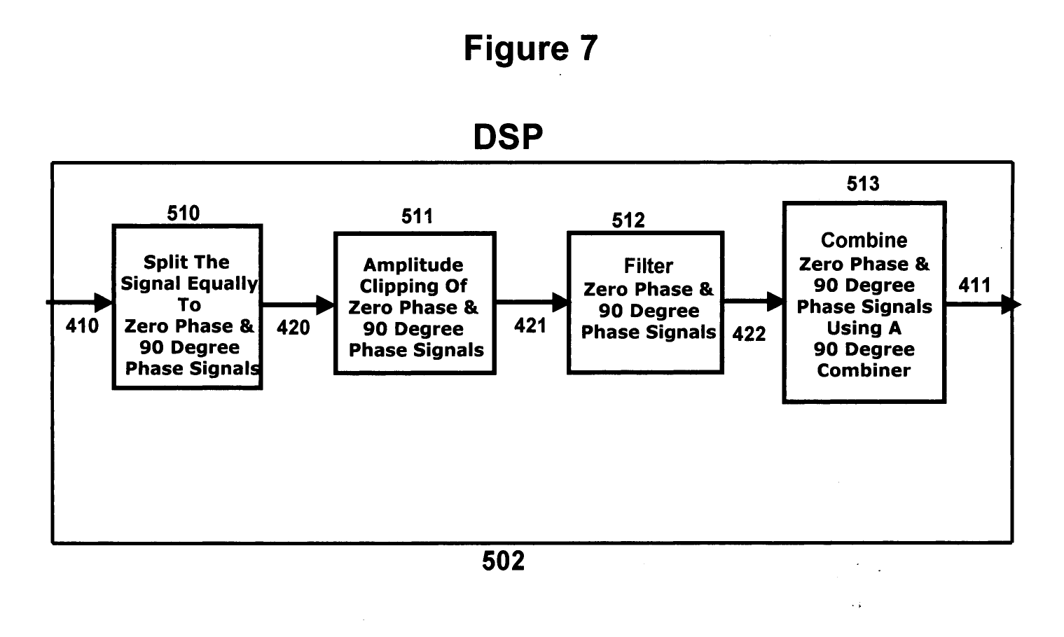

FIG. 7 shows the block diagram of the Crest Factor reduction block 502. The baseband signal 410 is divided into two equal components one having 90 degree phase shift by block 510 to produce signal 420. The equal amplitude signals with 90 degree phase 420 have their amplitude clipped by amplitude clipping block 511 to produced amplitude limited signals 421. The amplitude limited signals 421 is then filtered by block 512 to produce the amplitude clipped and filter signals 422. The amplitude clipped and filtered signal with 90 degree phase shifts 422 then combined by a combiner 513 that applies 90 degree phase shift to the signal with no phase shift to produce the combined Crest Factor reduced signal 411.

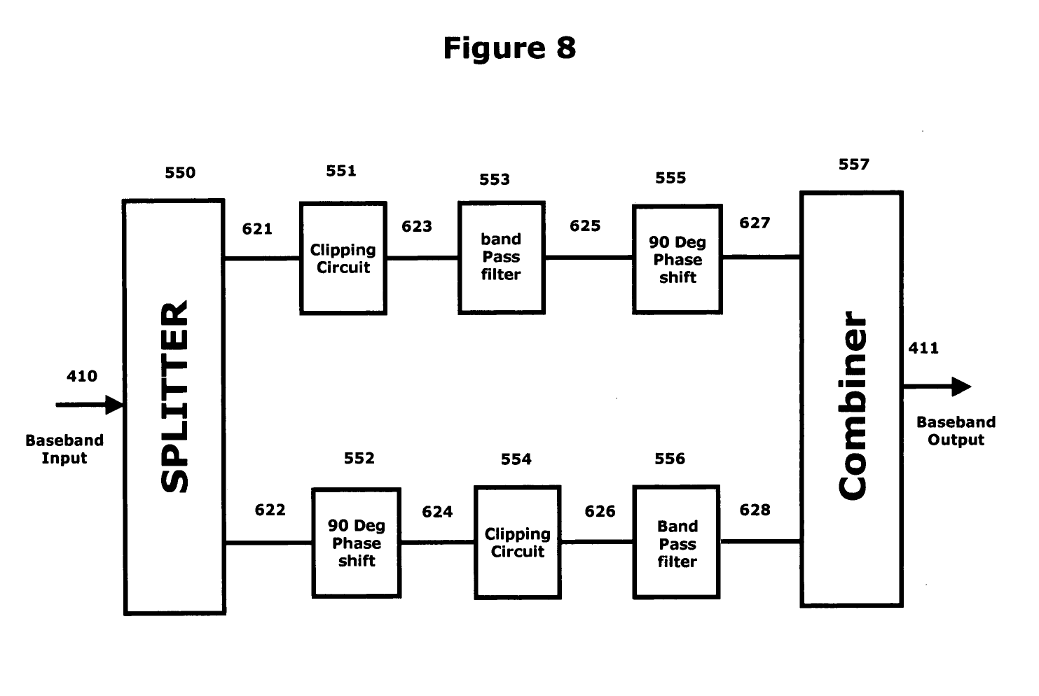

FIG. 8 shows the detail block diagram of the Crest Factor reduction circuit when the baseband signal is real. The baseband signal 410 from the receiver is split to two equal amplitude signals 621 and 622 by splitter block 550. The real baseband signal 621 is applied to amplitude clipper block 551 to produced amplitude clipped signal 623. The real baseband signal 622 is first 90 degree phase shifted by phase shifter block 552 to produce signal 624. Then the phase shifted signal 624 is applied to amplitude clipper block 554 to produce amplitude clipped signal 626. The amplitude clipped signals 623 and 626 are then band pass filtered by blocks 553 and 556 to produce signals 625 and 628. The filtered signal 625 is then 90 degree phase shifted by phase shifter block 555 to produce signal 627. The signals 627 and 628 are combined by combiner block 557 to produce Crest Factor reduced signal 411.

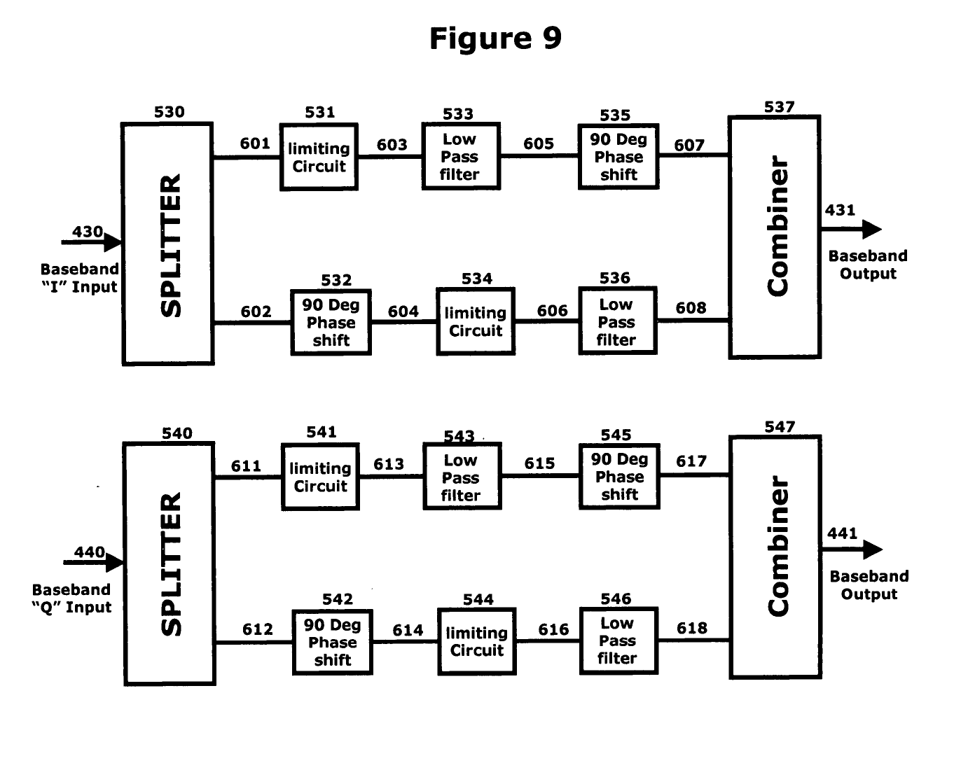

FIG. 9 shows the detail block diagram of the Crest Factor reduction circuit when the baseband signal is complex. The real or in phase “I” signal and the imaginary or quadrature “Q” signal have independently their amplitude clipped based on magnitude of the complex signal. The real component of baseband signal from the receiver, the signal 430 is split to two equal amplitude signals 601 and 602 by splitter block 530. The real baseband signal 601 is applied to amplitude limiting block 531 to produced amplitude limited signal 603. The real baseband signal 602 is first 90 degree phase shifted by phase shifter block 532 to produce signal 604. Then the phase shifted signal 604 is applied to amplitude limiting block 534 to produce amplitude limited signal 606. The amplitude limited signals 603 and 606 are then low pass filtered by blocks 533 and 536 to produce signals 605 and 608. The filtered signal 605 is then 90 degree phase shifted by phase shifter block 535 to produce signal 607. The signals 607 and 608 are combined by combiner block 537 to produce Crest Factor reduced real signal 431.

The imaginary component of baseband signal from the receiver, the signal 440 is split to two equal amplitude signals 611 and 612 by splitter block 540. The imaginary baseband signal 611 is applied to amplitude limiting block 541 to produced amplitude limiting signal 613. The imaginary baseband signal 612 is first 90 degree phase shifted by phase shifter block 542 to produce signal 614. Then the phase shifted signal 614 is applied to amplitude limiting block 544 to produce amplitude limiting signal 616. The amplitude limiting signals 613 and 616 are then low pass filtered by blocks 543 and 546 to produce signals 615 and 618. The filtered signal 615 is then 90 degree phase shifted by phase shifter block 545 to produce signal 617. The signals 617 and 618 are combined by combiner block 547 to produce Crest Factor reduced imaginary signal 441.

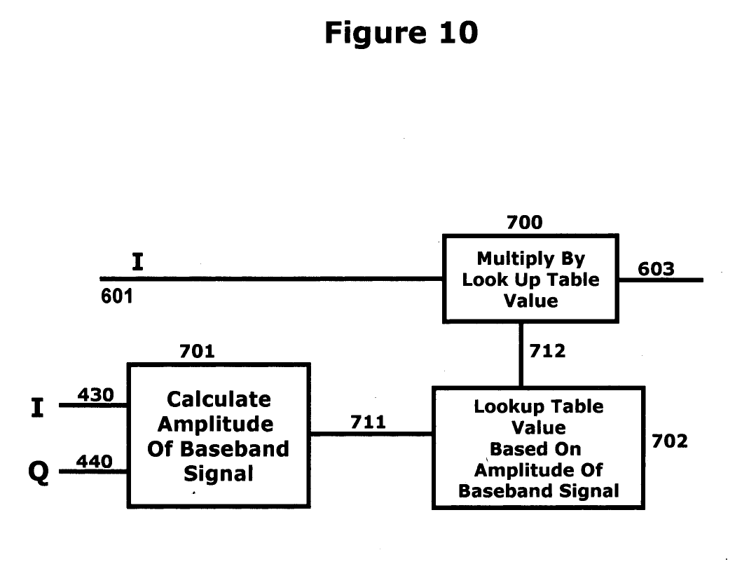

FIG. 10 shows the block diagram of the limiting function if the signal is complex. The real part or the imaginary part of the complex signal are multiplied by a factor whose value is determined by a look up table. The look up table values are based on the magnitude of the complex signal. In the case of the real component “I” the signal 601 is applied to block 700 where it is multiplied by the factor 712 taken from look up table 702 using the magnitude of the complex signal 711 created in block 701 using the “I” signal 430 and the “Q” signal 440.

What is claimed is:

1. A wireless Crest Factor reduction circuit for use with non-constant envelope signals in a wireless communication system to enhance the linearity and performance of the amplifier, in particular wireless cellular, PCS, wireless LAN, line of sight microwave, military, and satellite communication systems and any other none wireless applications, the Crest Factor reduction circuit comprising:
A receiver for the Crest Factor reduction of IF or RF input signal to amplifier. If the input signal is baseband then the receiver is bypassed.
An IF/RF Crest Factor reduction circuit implemented in analog domain at the frequency of the wireless signal using the IF/RF signal and its 90 degree phase shifted component.
A digital signal processing block to reduce the Crest Factor of the input baseband real signal using a similar approach used for IF/RF Crest Factor reduction circuit in digital domain.
A digital signal processing block to reduce the Crest Factor of a complex baseband signal applying the same approach used for IF/RF Crest Factor reduction in analog domain
A digital signal processing block to limit the amplitude of the real and imaginary part of a complex baseband signal.
A transmitter block that prepare the Crest Factor reduced signal for delivery to amplifier.

2. The Crest Factor reduction circuits according to claim 1, wherein the RF/IF signal from the wireless transmitter is directly applied to a Crest factor reduction circuit at RF or IF frequency.

3. The Crest Factor reduction circuits according to claim 1, wherein the RF or IF signal from the wireless transmitter is divided into two identical signal with 90 degree phase shift called in-phase and quadrature phase components. The two signals are then individually amplitude clipped and band pass filtered. The in-phase signal after being amplitude clipped and band pass filtered is 90 degree phase shifted before being combined with the amplitude clipped and band pass filtered quadrature signal to produce the Crest Factor reduced RF or IF signal.

4. The Crest Factor reduction circuits according to claim 1, wherein the RF or IF signal from the wireless transmitter is divided into two identical signal with 90 degree phase shift called in-phase and quadrature phase components. The two signals are then individually amplitude clipped. The in-phase signal after being amplitude clipped is 90 degree phase shifted before being combined with the amplitude clipped quadrature signal to produce the Crest Factor reduced RF or IF signal.

5. The Crest Factor reduction circuit according to claim 1, wherein input signal from the wireless transmitter is sampled using sub-harmonic sampling technique at the input frequency or at an intermediate frequency.

6. The Crest Factor reduction circuit according to claim 1, wherein the input signal from the wireless transmitter is sampled using sub-harmonic sampling technique at the input frequency or at an intermediate frequency and the digitized input signal is decimated to the appropriate number of samples per symbol for further digital signal processing.

7. The Crest Factor reduction circuit according to claim 1, wherein the input signal from the wireless transmitter is baseband and is sampled using Nyquist sampling technique and interpolated to produce the baseband signal with appropriate number of samples per symbol.

8. The Crest Factor reduction circuit according to claim 1, wherein the input signal from the wireless transmitter are in bit domain and the bit domain baseband signal is converted to sample domain baseband signal with appropriate number of samples per symbol.

9. The Crest Factor reduction according to claim 1, wherein the digital baseband signal is real. The real baseband signal is divided into two identical real components one in-phase and one with 90 degree phase shift or quadrature phase. The two signals then are individually amplitude clipped and low pass filtered. The in-phase signal after being amplitude clipped and low pass filtered is 90 degree phase shifted before being combined with the amplitude clipped and low pass filtered quadrature signal to produce the Crest Factor reduced baseband real signal.

10. The Crest Factor reduction according to claim 1, wherein the digital baseband signal is real. The real baseband signal is divided into two identical real components one in-phase and one with 90 degree phase shift or quadrature phase. The two signals then are individually amplitude clipped. The in-phase signal after being amplitude clipped is 90 degree phase shifted before being combined with the amplitude clipped quadrature signal to produce the Crest Factor reduced baseband real signal.

11. The Crest Factor reduction according to claim 1, wherein the digital baseband signal is a complex signal. The real component of complex baseband signal is divided into two identical real components one in-phase and one with 90 degree phase shift or quadrature phase. The two signals then are individually amplitude limited and low pass filtered. The in-phase signal after being amplitude limited and low pass filtered is 90 degree phase shifted before being combined with the amplitude limited and low pass filtered quadrature signal to produce the new real component of the complex baseband signal. The imaginary component of complex baseband signal is divided into two identical imaginary components one in-phase and one with 90 degree phase shift or quadrature phase. The two signals then are individually amplitude limited and low pass filtered. The in-phase signal after being amplitude limited and low pass filtered is 90 degree phase shifted before being combined with the amplitude limited and low pass filtered quadrature signal to produce the new imaginary component of the complex baseband signal.

12. The Crest Factor reduction according to claim 1, wherein the digital baseband signal is a complex signal. The real component of complex baseband signal is divided into two identical real components one in-phase and one with 90 degree phase shift or quadrature phase. The two signals then are individually amplitude limited. The in-phase signal after being amplitude limited is 90 degree phase shifted before being combined with the amplitude limited quadrature signal to produce the new real component of the complex baseband signal. The imaginary component of complex baseband signal is divided into two identical imaginary components one in-phase and one with 90 degree phase shift or quadrature phase. The two signals then are individually amplitude limited. The in-phase signal after being amplitude limited is 90 degree phase shifted before being combined with the amplitude limited quadrature signal to produce the new imaginary component of the complex baseband signal.

13. The Crest Factor reduction according to claim 1, wherein in the case of complex baseband signal the real and imaginary components of the complex signal is used to calculate the magnitude of the complex baseband signal. Then the magnitude of the complex baseband signal is used to create a look up table to be used to limit the amplitude of the real and imaginary components of the complex baseband signal. Using this approach the complex baseband signal is Crest Factor reduced without any phase change.

14. The Crest Factor reduction circuit according to claim 1, wherein the Crest Factor reduced signal is digitally up converted and converted to analog domain at an intermediate frequency or the output frequency.

15. The Crest Factor reduction circuit according to claim 1, wherein the received signal strength of the input signal to Crest Factor reduction circuit and transmit signal strength of the output from the Crest Factor reduction circuit is dynamically measures to adjust the total gain of the Crest Factor reduction circuit to zero

16. The Crest Factor reduction circuit according to claim 1 and subsequent claims, when it is used in wireless cellular, wireless PCS, wireless LAN, microwave, wireless satellite, none wireless amplifiers, and any wireless communication systems used for military applications.

17. The Crest Factor reduction circuit according to claim 1, wherein the DSP function can be implemented in programmable logic, FPGA, Gate Array, ASIC, and DSP processor
